(19) United States
(12) Patent Application Publication
(10) Pub. No.: US 2024/0075571 A1
(43) Pub. Date: Mar. 7, 2024

(54) PALLET MAGAZINE

(71) Applicants: Thilo Wilhelm, Reno, NV (US); Sven Klatt, Carson City, NV (US)

(72) Inventors: Thilo Wilhelm, Reno, NV (US); Sven Klatt, Carson City, NV (US)

(21) Appl. No.: 18/239,062

(22) Filed: Aug. 28, 2023

Related U.S. Application Data
(60) Provisional application No. 63/403,183, filed on Sep. 1, 2022.

(51) Int. Cl. B23Q 5/34; B65G 47/90

(52) U.S. Cl. CPC B23Q 5/34; B65G 47/901; B65G 2201/0267

(57) ABSTRACT

A workpiece supply system may be provided to enable automatic loading of workpieces to be machined into a CNC machining center and to retrieve finished workpieces from the CNC machining center. The workpiece supply system may include a shelf arrangement that stores a number of pallets each bearing one or more workpieces in a vertical and horizontal arrangement. A pallet retrieval unit may engage the pallets on the shelves and a gantry may maneuver the pallet retrieval unit into the CNC machining center. The pallet retrieval unit may engage a pallet clamping base within the CNC machining center to unlock a pallet bearing a finished workpiece and then exchange the finished workpiece pallet for a new workpiece pallet.

### CROSS REFERENCE TO RELATED APPLICATIONS

This application claims priority to U.S. Provisional Patent Application Ser. No. 63/403,183, filed 1 Sep. 2022, the entire contents of which are incorporated herein by reference.

### FIELD OF THE INVENTION

The present invention relates to an automated device for loading pallets into a Computer Numerical Control (CNC) machining system.

### BACKGROUND OF THE INVENTION

CNC machining systems provide accurate and efficient machining of workpieces. The automated operation can save significant labor costs while removing human induced errors. However, human intervention is often still required at the beginning and ending of each machining cycle to load and unload workpieces from the CNC machining center.

What is required is a system and process for automatically supplying workpieces to a CNC machining center.

### SUMMARY OF ONE EMBODIMENT OF THE INVENTION

Advantages of One or More Embodiments of the Present Invention

The various embodiments of the present invention may, but do not necessarily, achieve one or more of the following advantages:

The ability to automatically load a CNC machining center with a new workpiece(s); in this instance and subsequent ones: a pallet can hold a single or multiple workpieces.

The ability to automatically remove a finished workpiece from a CNC machining center;

Provide for continuous operation of a CNC machining center through multiple cycles with minimal human input;

Provide a combination of pallet magazine rack and robot to load, unload and store pallets;

Provide fast pallet exchange using a pallet rotator;

Provide an air shaft as part of the pallet rotator to provide precise locating of the pallet rotator, supply actuation air to unlock pallets from the pallet clamping base as well as mechanically support the pallet rotator.

Provide a space saving design due to vertical arrangement of pallets and minimum space required for pallet retrieval robot due to the arrangement of the robot movement axis.

These and other advantages may be realized by reference to the remaining portions of the specification, claims, and abstract.

### BRIEF DESCRIPTION OF ONE EMBODIMENT OF THE PRESENT INVENTION

A workpiece supply system may be provided to enable automatic loading of workpieces to be machined into a CNC machining center and to retrieve finished workpieces from the CNC machining center. The workpiece supply system may include a shelf arrangement that stores a number of pallets each bearing at least one workpiece. The shelf arrangement may support the pallets in a vertical and horizontal arrangement. A pallet retrieval unit may engage the pallets on the shelves and a gantry may maneuver the pallet retrieval unit into the CNC machining center. The pallet retrieval unit may engage a pallet clamping base within the CNC machining center to unlock a pallet bearing a finished workpiece and then exchange the finished workpiece pallet for a new workpiece pallet.

In one aspect of the present invention, there is provided an automatic workpiece supply system for supplying one or more workpieces to a CNC machining system. The automatic workpiece supply system may comprise a pallet supply that stores a plurality of pallets configured to support at least one workpiece. A pallet retriever may be configured to retrieve a pallet supporting at least one workpiece to be machined from the pallet supply and supply the retrieved pallet to the CNC machining system.

In one aspect of the present invention, there is provided a method of exchanging a workpiece in a CNC machining center. The method may comprise receiving by a workpiece retrieval unit a new workpiece request from the CNC machining center. The workpiece retrieval unit may retrieve a pallet supporting at least one new workpiece. The workpiece retrieval unit bearing the pallet supporting the at least one new workpiece may be received into the CNC machining center where a finished pallet supporting at least one finished workpiece is exchanged for the pallet supporting the at least one new workpiece. The finished pallet may be removed from the CNC machining center by the workpiece retrieval unit.

In one aspect of the present invention, there is provided an automatic workpiece supply system for supplying one or more workpieces to a CNC machining system. The automatic workpiece supply system may comprise pallet supply means for storing a plurality of pallets configured to support at least one workpiece. There may also be pallet retriever means for retrieving a pallet supporting at least one workpiece to be machined from the pallet supply and supplying the retrieved pallet to the CNC machining system.

In one aspect of the present invention, there is provided a pallet clamping base for use in a CNC machining center for securing a pallet bearing at least one workpiece to be machined, the pallet clamping base may comprise at least one pallet engagement mechanism for securing a pallet to the pallet clamping base, at least one automatically releasable pallet locking mechanism for releasably locking the at least one pallet engagement mechanism, a pallet retriever engagement mechanism for releasably engaging a pallet retriever that locates a pallet onto the pallet clamping base wherein the pallet clamping base is configured such that the pallet retriever is able to actuate the at least one pallet locking mechanism when the pallet retriever is engaged with the pallet clamping base.

In one embodiment, the pallet clamping base is able to engage the pallet retriever such that the pallet retriever is able to actuate the at least one pallet locking mechanism to unlock a first pallet secured to the pallet clamping base, remove the first pallet from the pallet clamping base, place a second pallet onto the pallet clamping base and actuate the at least one pallet locking mechanism to lock the second pallet onto the pallet clamping base.

In one embodiment, the pallet retriever engagement mechanism provides a mounting axis about which the pallet retriever can rotate to exchange a first pallet on the pallet clamping base for a second pallet conveyed by the pallet retriever.

In one embodiment, the pallet locking mechanism is pneumatically activated. In one embodiment, the pallet clamping base includes an air channel between the pallet retriever engagement mechanism and the at least one pallet locking mechanism, wherein the air channel is configured to communicate a pneumatic signal from the pallet retriever, through the air channel of the pallet clamping base to the at least one pallet locking mechanism.

In one embodiment, the pallet locking mechanism is electrically actuated. The pallet clamping base may include an electrical engagement with the pallet retriever that allows an electrical signal to pass only when the pallet clamping base and the pallet retriever are properly physically connected. The electrical signal may pass from the pallet retriever to the at least one pallet locking mechanism through the pallet clamping base.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 substantially depicts a workpiece exchange system for a CNC machining center in accordance with an embodiment of the present invention;

FIG. 2 substantially depicts the inner components of a CNC machining center including a clamping base;

FIG. 3 substantially depicts details of the clamping base;

FIG. 4 substantially depicts a pallet magazine and pallet retrieval robot;

FIG. 5 substantially depicts an exploded view of the pallet magazine;

FIG. 6 substantially depicts the pallet retrieval robot supported by a gantry;

FIG. 7 substantially depicts the pallet retrieval robot including a pallet rotator;

FIG. 8 substantially depicts the pallet rotator supporting pallets;

FIG. 9 substantially depicts a perspective view of the pallet rotator;

FIG. 10 substantially depicts a top view of the pallet rotator;

FIG. 11 substantially depicts a cross section of line A-A of FIG. 10;

FIG. 12 substantially depicts an internal view of the pallet rotator;

FIG. 13 substantially depicts an exploded view of a pallet and a clamping base;

FIG. 14 substantially depicts a top view of a wedge receptacle;

FIG. 15 substantially depicts a side view of the wedge receptacle;

FIG. 16 substantially depicts a perspective view of the wedge receptacle;

FIG. 17 substantially depicts a cross section of the wedge receptacle taken through line A-A of FIG. 14;

FIG. 18 substantially depicts a wedge plate;

FIG. 19 substantially depicts a first step of a method for pallet exchange;

FIG. 20 substantially depicts a second step of a method for pallet exchange;

FIG. 21 substantially depicts details of an airlock engagement process;

FIG. 22 substantially depicts removing a pallet from the clamping base;

FIG. 23 substantially depicts rotation of the pallet rotator;

FIG. 24 substantially depicts a front view of an alternative embodiment of a wedge receptacle and wedge plate;

FIG. 25 substantially depicts a rear view of the wedge receptacle and wedge plate of FIG. 24;

FIG. 26 substantially depicts an alternative embodiment featuring a load/unload station;

FIG. 27 substantially depicts the load/unload station coupled to the pallet magazine and robot with the moveable guard in a closed position;

FIG. 28 substantially depicts a rear view of the load/unload station with the fixed guards removed;

FIG. 29 substantially depicts a front view of the load/unload station with the moveable guard in an open position; and

FIG. 30 substantially depicts a top view of the load/unload station in connection with the pallet magazine robot.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

There will be described herein one or more embodiments of an automated workpiece supply system that is configured to supply workpieces to be machined to a CNC machining station. The automated system includes a pallet retrieval unit that retrieves pallets supporting workpieces to be machined from a supply and supplies the pallet to the CNC machine. In the same process, the pallet retrieval unit is able to remove a pallet supporting a complete workpiece from the CNC machining center and return it to the supply, or provide it to an alternative dispatch area. This allows for unattended operation of CNC machining centers for prolonged periods of time.

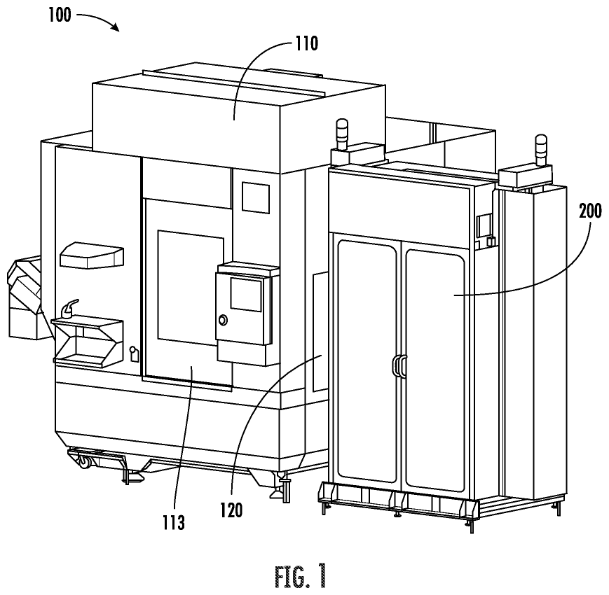

Apparatus 100 according to an embodiment of the invention is depicted in FIG. 1. The apparatus includes a CNC machining center 110 and a workpiece supply system 200 that tends the CNC machining center 110. Notable in FIG. 1 is that the workpiece supply system 200 is placed to the side of the CNC machining center 110, leaving full access through the front door 112 of the CNC machining center for possible manual operation. The machining operations of the CNC machining center 110 may be generally conventional. However, the workpiece loading and unloading operations of the CNC machining center may be modified to cooperate with the workpiece supply system 200. The CNC machining center 110 may be modified to include a side door 120 for engagement and interaction with the workpiece supply system 200. The side door 120 may be an automatically operated door. The workpiece supply system 200 loads and unloads pallets through the automatic operated door 120 on the side of the CNC machining center 110. The workpiece supply system 200 may control the side door 120. As will be described in more detail below, the workpiece supply system 200 has a control computer that is programmed through G-code. A simple ‘handshake’ is performed between the workpiece supply system 200 and the CNC machining center 110 using discrete I/O. The CNC machining center may request a ‘new’ pallet by sending a request to the workpiece supply system 200. The workpiece supply system 200 may remove any existing pallet, e.g. supporting a completed or finished workpiece, and provide a new pallet containing a fresh workpiece in a single action. The workpiece supply system 200 sends an output to the CNC machining center 110 to signal that the pallets have been exchanged and that machining can begin.

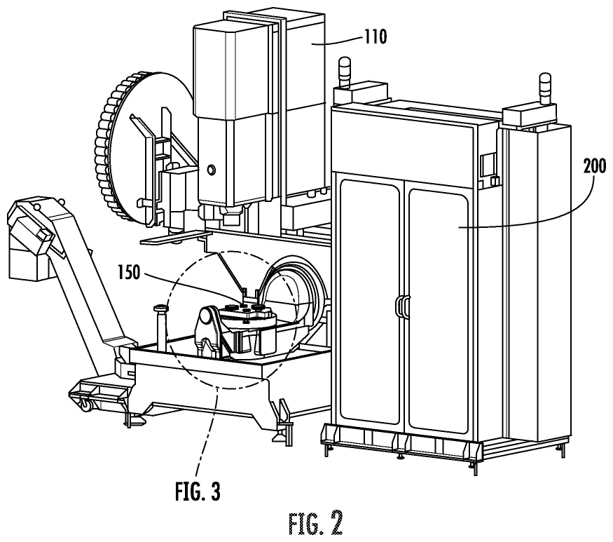

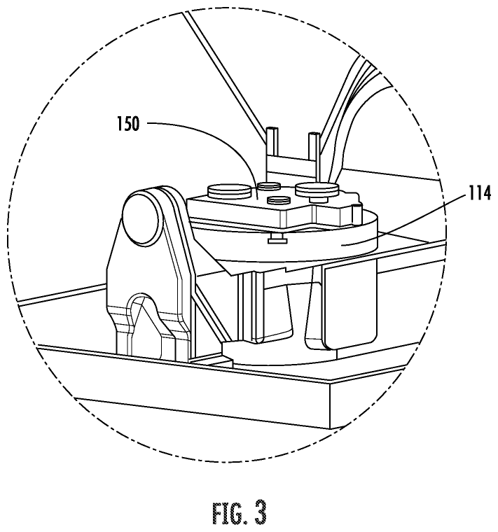

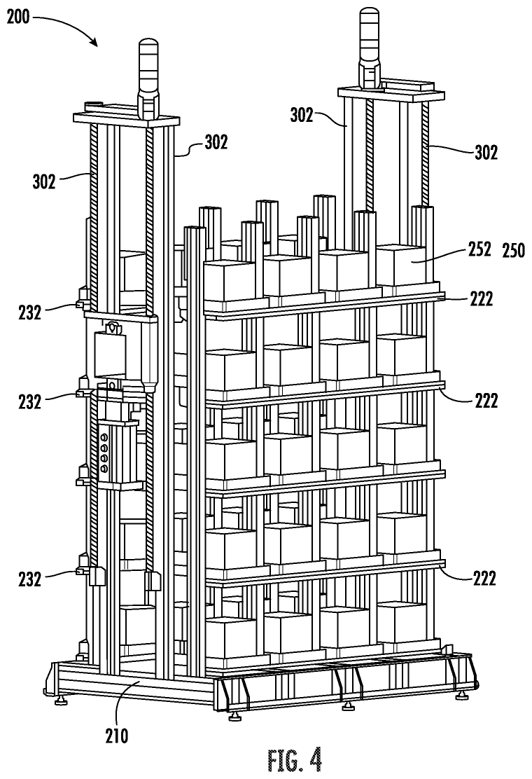

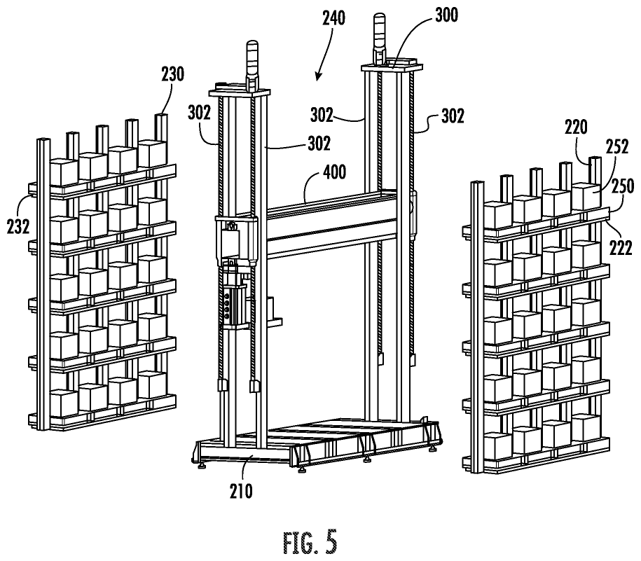

The CNC machining center 110 is further modified to include a pallet clamping base 150 as illustrated in FIG. 2. The clamping base 150, circled by ‘A’ in FIG. 2, is shown in further detail in FIG. 3 and described more fully below. The clamping base 150 is mounted inside the CNC machining center 110 on the machining table 114 of the CNC machining center 110. The pallet clamping base 150 may use commercially available clamping systems that are locked by internal spring force and unlocked by the application of compressed air. An example of a suitable clamping system is the APS Zero Point Clamping System from SMW-AUTOBLOK Spannsysteme GmbH. The pallet clamping base 150 is described in more detail further below. FIG. 4 shows the workpiece supply system 200 with external cover and some components removed. A partially exploded view of FIG. 4 is shown in FIG. 5. The workpiece supply system 200 includes a platform 210 that supports a gantry 300 centered over a longitudinal centerline of the platform 210. The gantry 300 includes a set of vertical uprights 302, two at each longitudinal end of the platform. To each lateral side of the gantry is a set of shelves 220, 230. Each set of shelves is supported on and affixed to the platform 210 and includes a plurality of vertically spaced shelves 222, 232. In the embodiment depicted, each set of shelves 220, 230 includes a vertical arrangement of five shelves, though any number of shelves may be provided based on space provisions, height of the workpieces, etc. Each shelf 222, 232 is able to support a plurality of pallets 250 in a horizontally spaced arrangement. Specifically, each shelf includes well defined pallet slots that hold a pallet in a fixed and controlled location that can be anticipated by the pallet retrieval unit. Each pallet 250 may support a workpiece 252. Though the workpiece 252 is shown singularly, it is to be understood that a pallet may also support multiple workpieces if required and that multiple workpieces may be machined on a single pallet. Each shelf is shown as defining four adjacent pallet slots, though any number of slots may be provided. The gantry 300 aids in defining a gap 240 between the shelves 220, 230. The gantry supports a pallet retrieval unit 400 such that the pallet retriever 400 is able to move vertically within the gap 240.

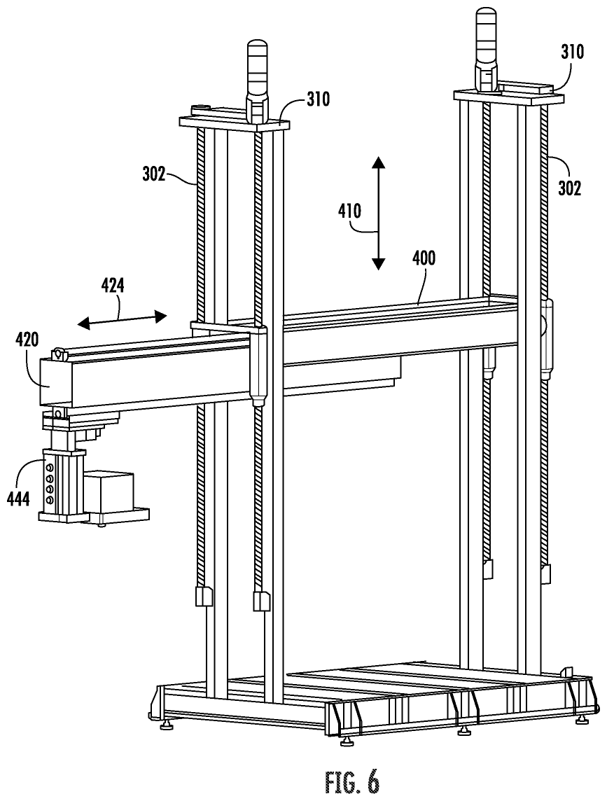

The gantry 300 is shown in more detail in FIG. 6. The uprights 302 at each end of the gantry 300 support the pallet retriever 400 between them and provide two vertical drive axes 310 for the robot 400. That is, the gantry facilitates up and down motion of the pallet retriever 400 as indicated by vertical arrow 410. The pallet retriever 400 includes an extension beam 420 that can move horizontally in and out of the pallet retriever 400 (arrow 424) between a nested or retracted position as shown in FIGS. 4 and 5 and an extended position as shown in FIG. 6. The gantry is laterally extendable with the horizontal ‘reach’ of the extension beam 420 being used to access the machining table inside the CNC machining center through a door (side door 120 in FIG. 1) of the CNC machining center.

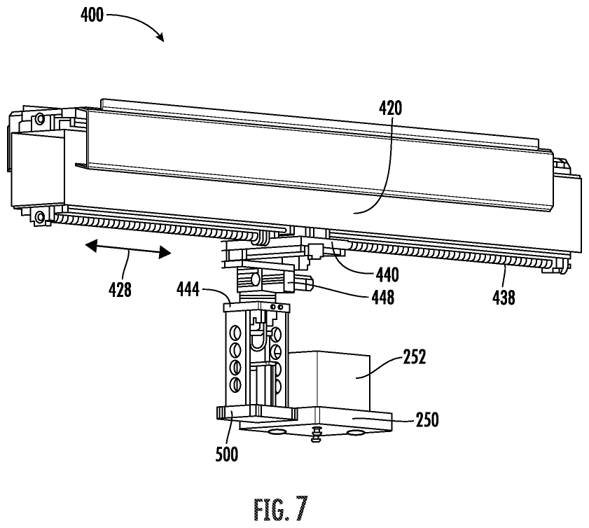

The pallet retriever 400 is shown in isolation in FIG. 7. Attached to the lower side of the extension beam 420 is a cross slide 440 that has a pallet rotator 444 attached to it via a rotating drive 448. The cross slide 440 and the attached pallet rotator 444 can move horizontally (arrow 428) along a track 438 provided on the underside surface of the extension beam 420. This movement is additional to and independent of the above-described horizontal movement of the extension beam 420. The pallet rotator 444 is configured to controllably engage and release a pallet using a wedge plate on the pallet and a complementary wedge plate receptacle on the pallet rotator 444 as will be described in more detail below. More particularly, in one embodiment, the pallet rotator may have two ends, each of which is able to independently engage and release a pallet 250.

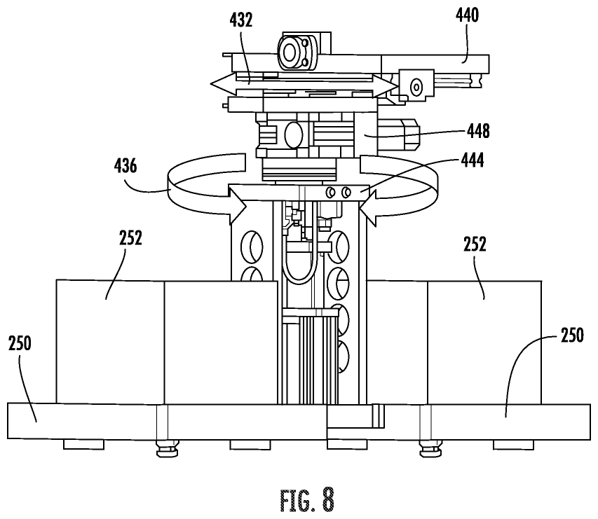

As shown in FIG. 8. the cross slide 440 can move horizontally in the direction of the arrow 432, this movement is independent of and perpendicular to the above-described horizontal motion 428 along the extension beam 420. Through the rotating drive 448 the pallet rotator 444 can be rotated around the vertical axis as indicated by arrows 436. The pallet rotator 444 is shown in FIG. 8 with two pallets 250, each supporting a workpiece 252. The pallets 250 are attached to the pallet rotator through a wedge plate and receptacle system that is further described below.

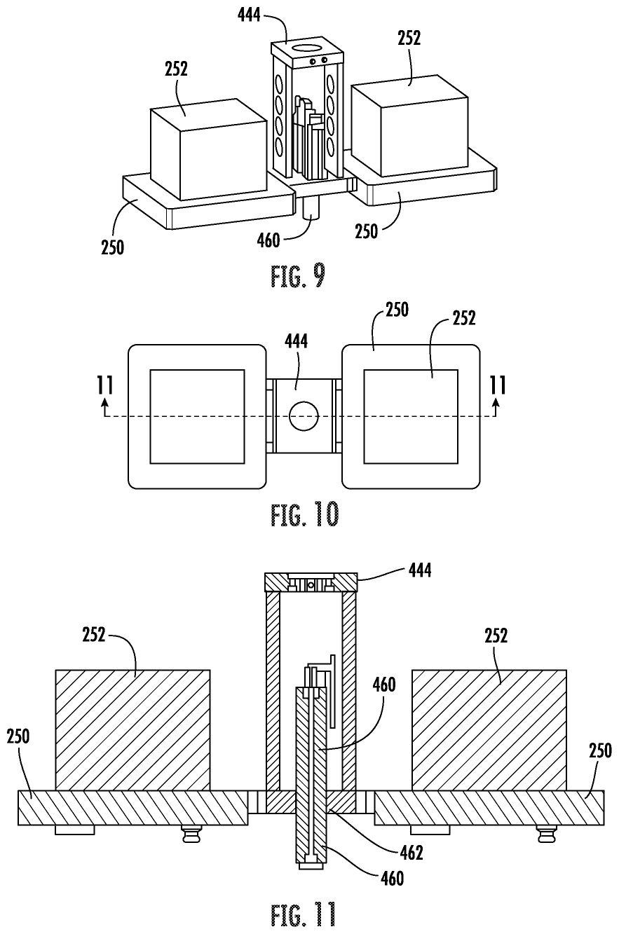

FIGS. 9 and 10 show the pallet rotator in perspective and top views respectively. In each view, the pallet rotator is shown having engaged a pallet 250 which in turn supports a workpiece 252. FIG. 11 shows a cross section taken through A-A of FIG. 10. A more detailed cross section of just the pallet rotator 444 is shown in FIG. 12. The pallet rotator 444 has an air shaft 460 that is guided by guide bushings 462. The air shaft is connected to a cylinder connector plate 466 to enable the air shaft to be actuated up and down via air cylinders 468. The air shaft 460 has an internal air passage 464 to supply compressed air.

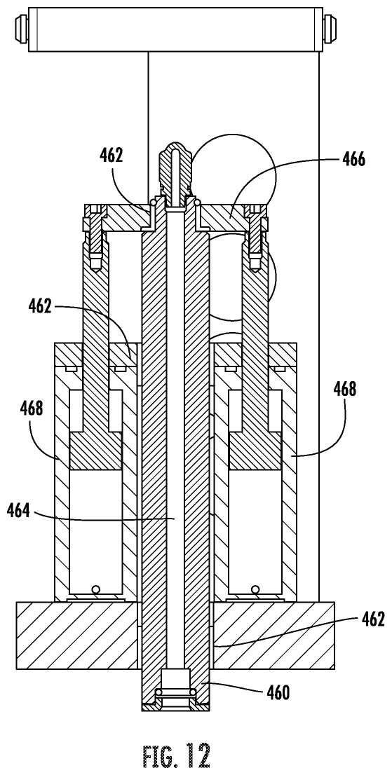

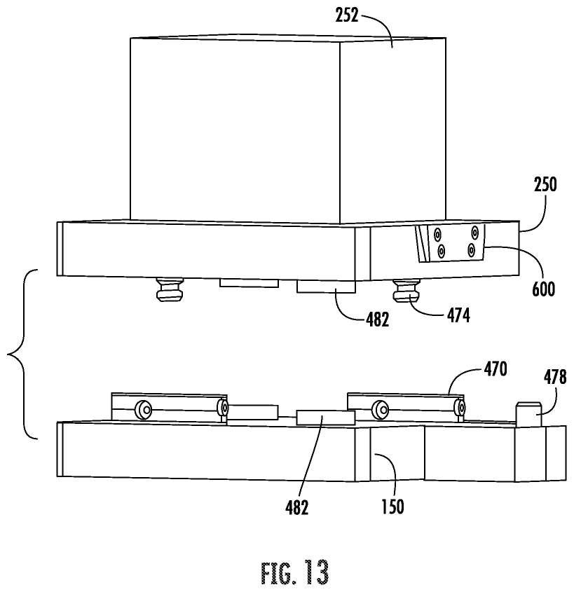

The pallet clamping base 150, an embodiment of which is illustrated in FIG. 13 utilizes a clamping system 470, commercially available examples of which have been provided previously, that are locked by internal spring force and unlocked by the application of compressed air. The underside of the pallet has retention studs 474 that are held in the clamping receptacles 470 by internal springs. To release the studs 474 from the clamping receptacles 470, compressed air is supplied to the air pin 478 (shown covered here by a protection sleeve). The compressed air is supplied by the air shaft 460. The underside of the pallet 250 and the top side of the clamping base 150 each have support plates 482 to facilitate securing of the pallet 250 onto the clamping base 150 to ensure steadiness of the workpiece 252 during machining.

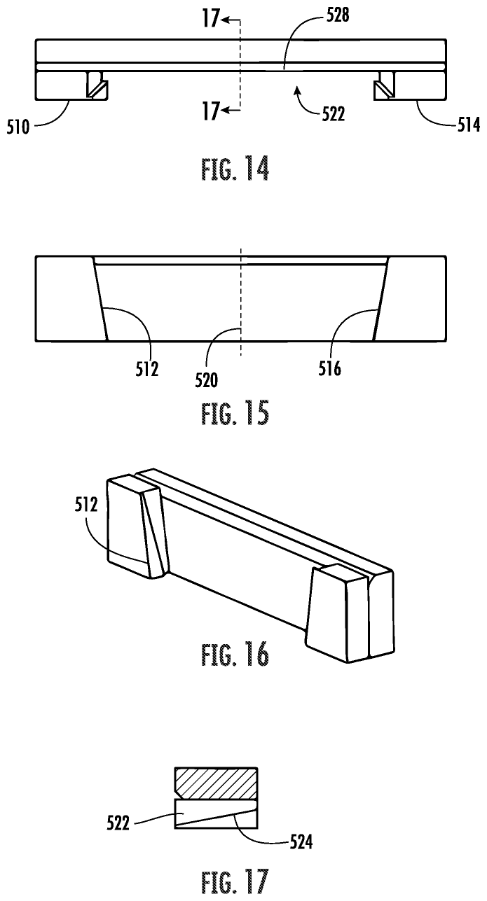

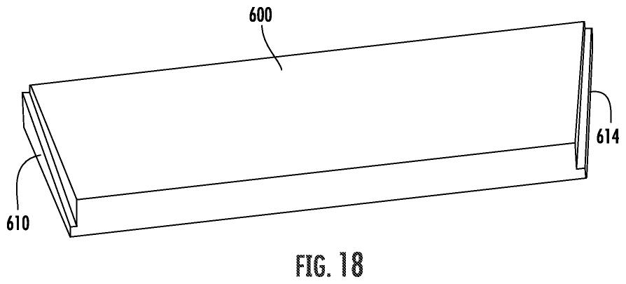

FIGS. 14-17 show embodiments of the wedge receptacles 500 that are attached on opposing mounting surfaces on the pallet rotator 444 (FIG. 7). The wedge receptacles 500 have two retention features 510 and 514 with tapers 512, 516 toward the centerline 520. The wedge receptacles 500 and the retention features define a wedge shaped slot 522 that receives and retains a complementary wedge plate provided on an edge of the pallets. As shown in FIG. 17, the slot 522 also has a taper 524. FIG. 18 shows an embodiment of a complementary wedge 600 that is provided on an edge of the pallets (also shown in FIG. 13). The wedge plate 600 is attached to the pallet and fits in between the two retention features 510, 514. The retention features 610, 614 of the wedge plate 600 are essentially the negative of the retention feature 510, 514 in the wedge receptacle 500. To engage a pallet, the pallet rotator moves in from the side and beneath the pallet until the wedge receptacle 500 is beneath the wedge plate 600 of the pallet. The pallet rotator then elevates and the wedge of the pallet enters the tapered slot 522 defined by the wedge receptacle. The taper 524 in conjunction with the retention features 510, 514 draws the wedge plate 600 that is attached to the pallet towards the front face 528 of the wedge receptacle 522 back plate. Further elevation of the pallet rotator 444 raises the pallet, e.g. to lift the pallet off the shelf of the pallet magazine, or the clamping base of the CNC machining center. The wedge and wedge receptacle system provides for a passive pallet pick up, negating the need for an actuator.

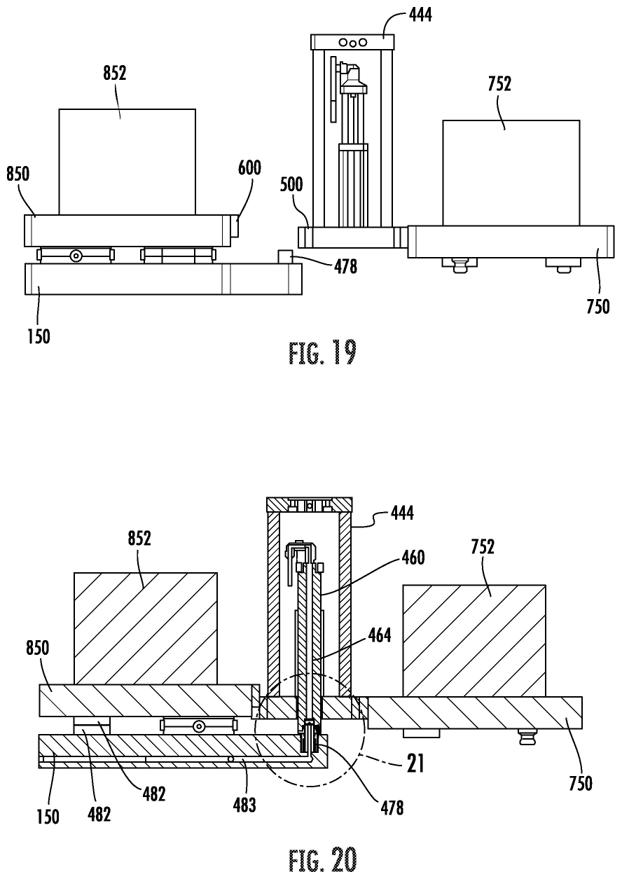

A process for pallet exchange will now be described with reference to FIGS. 19 to 22. A first step of the process is shown in FIG. 19. The pallet rotator 444 is shown having retrieved a new pallet 750 from the pallet magazine. The retrieved pallet supports a new workpiece 752 to be machined. The term “new” as used herein is to imply that the pallet supports a workpiece to be machined by the upcoming process, rather than a finished workpiece that has just completed the particular machining process. The workpiece to be machined may have had other machining steps performed previously and thus may not be “new” in that context. Similarly, a finished workpiece as used herein implies a workpiece that has complete this particular CNC process, though the workpiece may require further machining processes, including other CNC processes, subsequently. The terms new pallet and finished pallet refer to the workpiece(s) supported by the pallet, not the age or state of the pallet itself. Further, while the description herein makes reference to a single workpiece on a pallet for clarity, it is to be understood that a single pallet may support multiple workpieces to be machined. The pallet rotator moves from right to left, as depicted, through the door of the CNC machining center (not shown). The retrieved pallet 750 is at the trailing edge of the pallet rotator 444. The free edge of the pallet rotator 444 with a free wedge receptacle 500 is the leading edge. The pallet rotator 444 moves into the CNC machining center from the side toward the clamping base 150. The clamping base 150 supports a finished pallet 850 that in turn supports a finished workpiece 852 that has been machined. The wedge receptacle 500 of the free edge of the pallet rotator 444 is disposed lower than the wedge 600 of the pallet 850 that is located on the clamping base 150. There is a clearance between the air pin 478 of the clamping base 150 and the bottom of the pallet rotator 444.

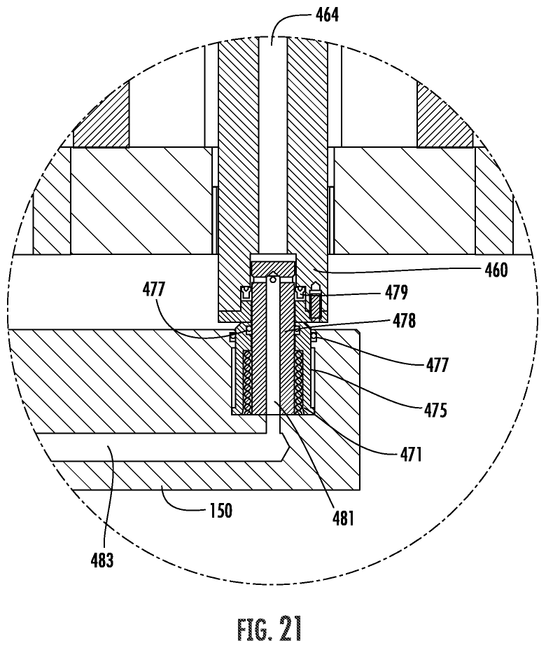

The pallet rotator 444 moves until the air shaft 460 is aligned over the air pin 478 of the clamping base 150 (FIG. 20). The air shaft then extends down to engage the air pin. A detailed depiction is shown in FIG. 21. When the air shaft 460 is extended down over the air pin 478 it pushes the spring-loaded 471 protection sleeve 475 down. The protection sleeve 475 is sealed to the air pin 478 and the housing by seals 477 to protect the air pin 478 during CNC machining center operations from coolant and chips. The air seal 479 contained as shown in the air shaft 460 seals on the outside diameter of the air pin 478. Compressed air can now be supplied through the air passage 464 of the air shaft 460 of the pallet rotator 444 and can flow through the small radial holes of the air pin 478. The air passage 481 in the air pin 478 is connected to internal air passages 483 in the clamping base that are connected to the clamping system receptacles 470. The supplied compressed air unlocks the clamping system receptacles 470 and therefor releases the pallet 850.

This system accomplishes multiple tasks:
It provides precise locating of the pallet rotator.
It supplies compressed air to unlock pallets from the pallet clamping base.
It provides support when the extension beam is extended to its maximum position and when the maximum load is exerted onto the extension beam and pallet rotator, being the only time when two pallets are attached to the rotator 444. The actuator that moves the air shaft down consequently also assists in the lifting of the two pallets.

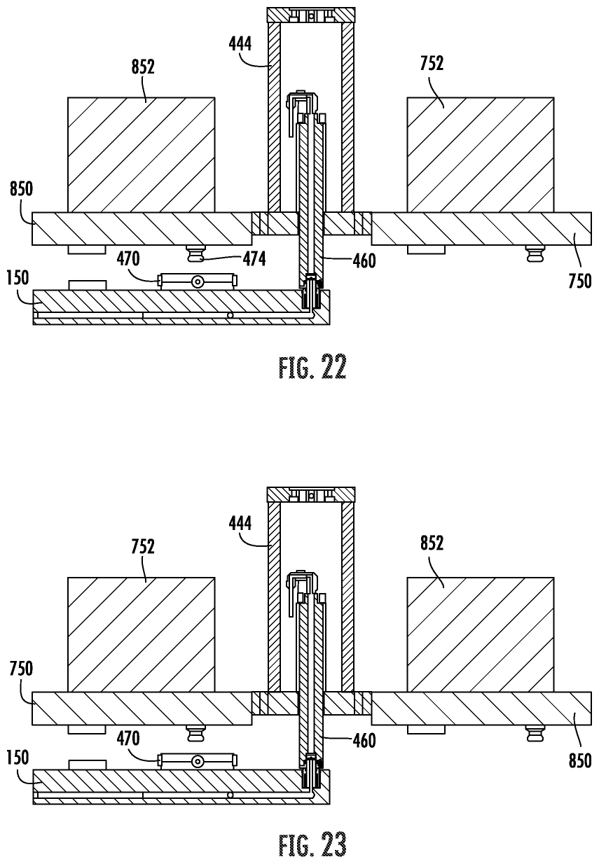

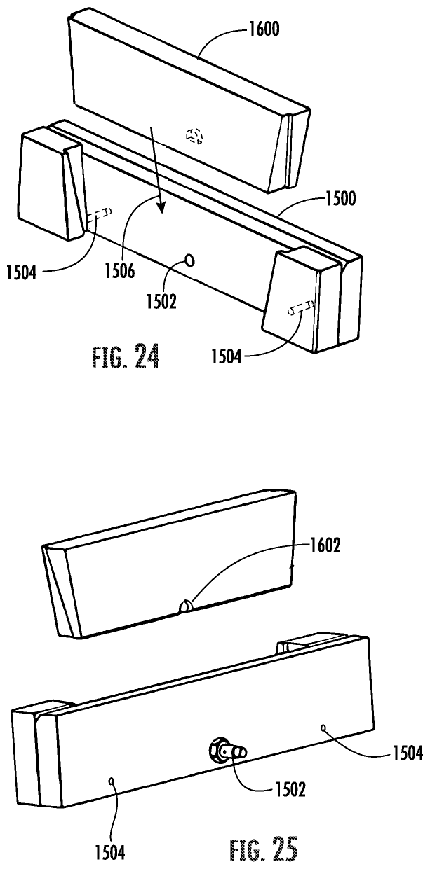

Once the pallet 850 is unlocked from the pallet clamping base 150 the pallet rotator 444 is moved up (FIG. 22). As described, this move is assisted by the actuator that pushes the air shaft downwards to help support the weight of the two pallets and workpieces. The pallet rotator then rotates 180 degrees to move the new pallet into position over the pallet clamping base (FIG. 23). The steps are then reversed. That is:
The pallet rotator is moved down, placing the new pallet 750 (now on left side as depicted in FIG. 23) onto the clamping base 150 and releasing the new pallet from the wedge receptacle.
The compressed air supply is stopped so that the clamping base locks re-engage and lock the new pallet onto the clamping base.
The air shaft is moved completely up and thereby disengages from the air pin.
The pallet rotator is moved away from the clamping base to store the pallet with the machined piece in the magazine.

While a pneumatic engagement between the pallet rotator 444 and the pallet clamping base 150 is shown and described, in an alternative embodiment, the engagement may be electrical. That is, an mechanical/electrical connection may be used in place of the air pin 478 so that when the pallet rotator 444 physically engages the pallet clamping base 150, an electrical connection is also made. Electrical signals may then pass from the pallet rotator 444, through wiring or other electrical conduits of the clamping system base 150 to electrically actuated clamping system receptacles 470. In further embodiments, the engagement may be mechanical or hydraulic.

FIGS. 24 and 25 illustrate an alternative embodiment of the pallet rotator wedge receptacle 1500 and the pallet wedge plate 1600 that facilitate the pallet pick up. In this embodiment, the wedge receptacle 1500 includes a sensor 1502, shown in the lower center of the wedge receptacle 1500. When the wedge plate 1600 is properly engaged (engagement direction shown by arrow 1506) the sensor 1502 senses the presence of the wedge plate 1600 and generates a signal that can be utilized by the computer control of the pallet magazine robot. The primary sensor may be electric, electronic, mechanical or pneumatic. Air blow holes 1504 may be provided and connected to an air source (not shown) to aid in the removal of chips, swarf, machining fluids etc., to keep the engagement surfaces of the wedge receptacle clean 1500. While two air blow holes 1504 are shown at locations to provide air to the retention features of the wedge receptacle, the number and distribution of air blow holes may be varied as needed.

In the rear view shown in FIG. 25, there is shown a relief 1602 cut into the wedge plate 1600 at a location that aligns with the sensor 1502 located in the wedge receptacle 1500 when the wedge plate 1600 is properly engaged into the wedge receptacle 1500. The relief 1602 may be used to adjust the sensitivity of the sensor 1502, i.e. how much misalignment of the wedge plate is permissible while still generating a signal.

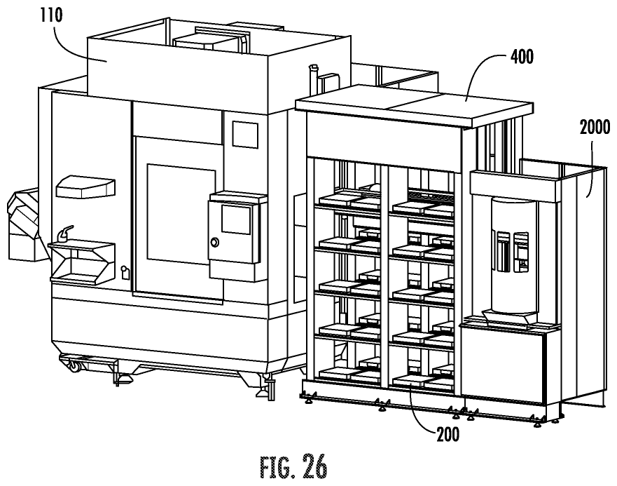

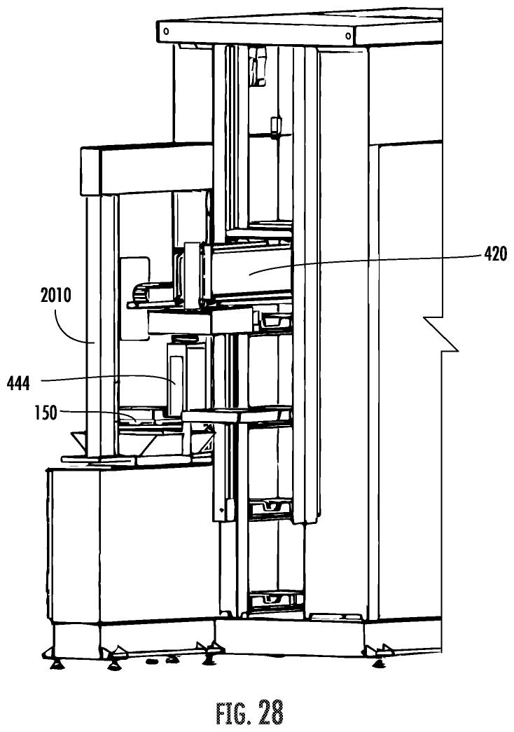

FIGS. 26 to 30 show an alternative embodiment of a pallet magazine featuring the addition of a load/unload station 2000 to remove finished workpieces from the pallet and mount new, to be machined blanks, workpieces or material onto the pallets. As shown in FIGS. 26 to 30, the load/unload station 2000 is attached to the pallet magazine robot 400 opposite to the CNC machining center 110. The load/unload station 2000 is integrated with the pallet magazine robot 400 which is able to take loaded pallets 250 from the station 2000 and place them into the pallet magazine 200. Likewise, finished pallets 250 can be taken from the pallet magazine 200 and placed into the station 2000 for removal by the operator.

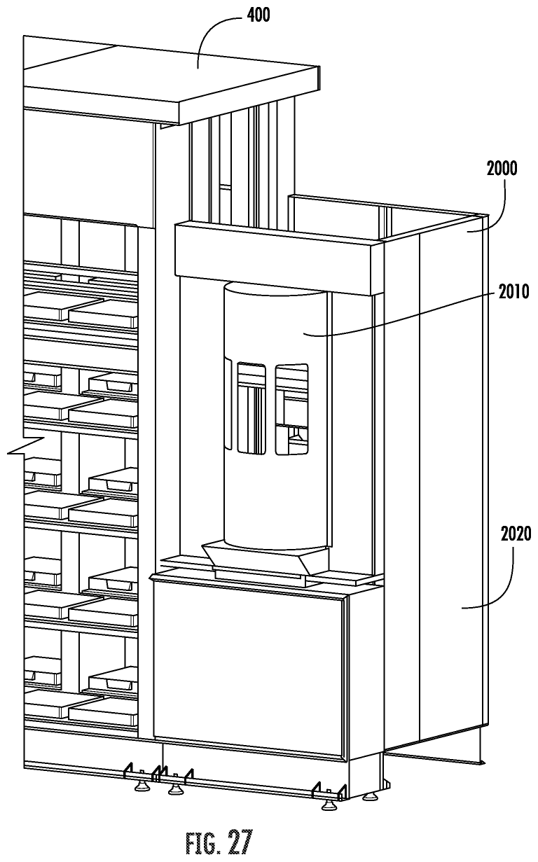

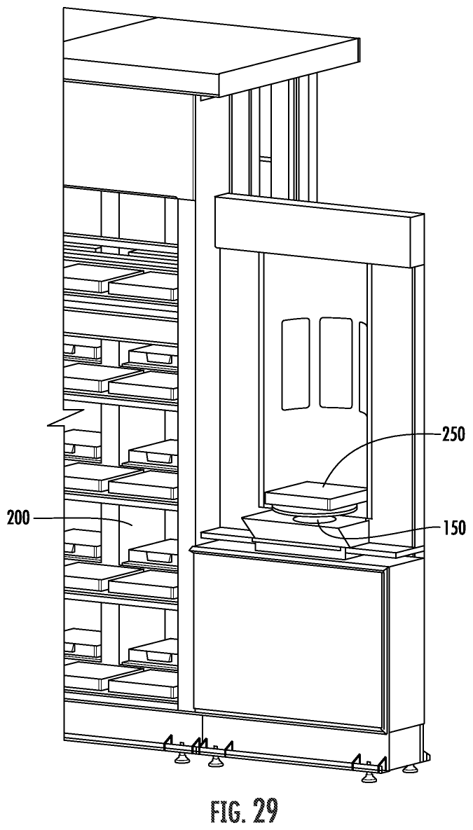

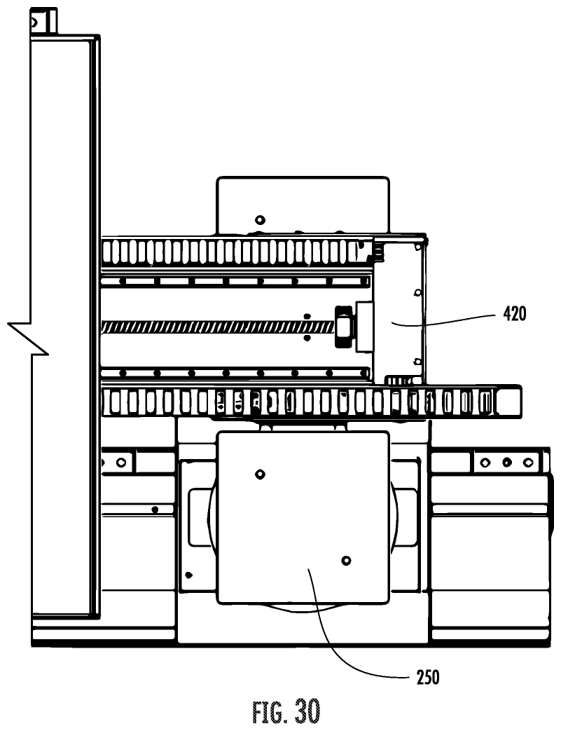

The load/unload station 2000 has a (round) movable guard 2010 that can be rotated 180 degrees around its center axis. Fixed guards 2020 enclose the remaining sides to safeguard the operator from motion of the extension beam 420 and pallet rotator 444 that operate behind them. Located behind the movable guard 2010 is a clamping base 150 similar to the one previously described herein. With the movable guard closed as shown in FIG. 27 the pallets 250 to be unloaded/loaded can be safely placed in the clamping base 150. Once the extension beam 420 and pallet rotator 444 have moved away from the clamping base 150, the movable guard can be opened by rotating it 180 degrees around its center axis. This exposes the pallet 250 loaded onto the clamping base to the operator for finished workpiece removal and mounting of a new, to be machined, blank or material as shown in specifically in FIG. 29.

By providing a pallet magazine adjacent the CNC machining center and a robot for automatically loading the CNC machining center, the CNC machining center is able to operate through many machining cycles with minimal human intervention. G-code programming may control the movement of the robot. The programming of the CNC machining center may be modified to include programming to request new pallets from the pallet magazine when required, control the robot access door and to interface with the pallet magazine robot for exchange of pallets.

The arrangement of the pallet magazines on either side of the movement access of the loading robot with both vertical and horizontal stacking of the pallets allows a maximum number of pallets to be provided. Additional space efficiencies may be created by controlling the movement of the robot during retrieval of pallets from the shelves. In one embodiment, the pallet does not need to be inserted and removed from the pallet slot at an exactly lateral angle. Instead, by simultaneous lateral and longitudinal movement, the pallet retrieval robot can use an angled retrieval of a pallet and workpiece which may allow the two vertical arrangements of shelves to be more closely spaced.

Many modifications and other implementations of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific implementations disclosed, and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An automatic workpiece supply system for supplying one or more workpieces to a CNC machining system, the automatic workpiece supply system comprising:
(A) a pallet supply that stores a plurality of pallets configured to support at least one workpiece;
(B) a pallet retriever that is configured to retrieve a pallet supporting at least one workpiece to be machined from the pallet supply and supply the retrieved pallet to the CNC machining system.

2. The automatic workpiece supply system of claim 1 wherein the pallet retriever is configured to return a pallet supporting at least one machined workpiece retrieved from the CNC machining system to the pallet supply.

3. The automatic workpiece supply system of claim 1 wherein the pallet supply comprises a plurality of shelves in at least one vertical arrangement, wherein each shelf is configured to support a plurality of pallets in a horizontal arrangement.

4. The automatic workpiece supply system of claim 3 wherein the pallet retriever comprises a gantry that supports a pallet retrieval unit, wherein the at least one vertical arrangement of shelves is disposed adjacent the gantry and wherein the gantry is configured to support vertical and horizontal movement of the pallet retrieval unit to enable the pallet retrieval unit to retrieve a pallet from the plurality of shelves.

5. The automatic workpiece supply system of claim 4 comprising a vertical arrangement of shelves on each lateral side of a longitudinal axis of the gantry.

6. The automatic workpiece supply system of claim 4 wherein the gantry is longitudinally extendible to enable the pallet retrieval unit to pass through a door of the CNC machining system.

7. The automatic workpiece supply system of claim 6 comprising a control computer that is programmed to actuate opening of the door of the CNC machining system.

8. The automatic workpiece supply system of claim 1 wherein the pallet retriever is configured to exchange a pallet supporting a finished workpiece with a pallet supporting a new workpiece in the CNC machining system.

9. The automatic workpiece supply system of claim 8 wherein the pallet retriever is configured to unlock and remove a pallet from a pallet clamping base of the CNC machining system.

10. The automatic workpiece supply system of claim 9 wherein the pallet retriever comprises at least one pallet clamping base engagement mechanism for releasably engaging the pallet clamping base and at least one pallet engagement mechanism for engaging a pallet secured on the pallet clamping base by at least one automatically releasable pallet locking mechanism of the pallet clamping base, wherein the pallet retriever is configured to actuate the at least one pallet locking mechanism to release the pallet from the pallet clamping base.

11. The automatic workpiece supply system of claim 10 wherein the pallet retriever is configured to engage the pallet clamping base such that the pallet retriever is able to actuate the at least one pallet locking mechanism to unlock a first pallet secured to the pallet clamping base, remove the first pallet from the pallet clamping base, place a second pallet onto the pallet clamping base and actuate the at least one pallet locking mechanism to lock the second pallet onto the pallet clamping base.

12. The automatic workpiece supply system of claim 11 wherein the at least one pallet clamping base engagement mechanism comprises a rotation axis that allows the pallet retriever to rotate above the pallet clamping base engagement mechanism to exchange a first pallet on the pallet clamping base for a second pallet conveyed by the pallet retriever.

13. The automatic workpiece supply system of claim 11 wherein the pallet clamping base engagement mechanism connects with an air channel of the pallet clamping base that connects to the at least one pallet locking mechanism, wherein the pallet retriever is configured to provide a pneumatic signal to actuate the at least one pallet locking mechanism.

14. The automatic workpiece supply system of claim 11 comprising a load/unload station coupled to the pallet magazine for loading and unloading a pallet into the pallet supply.

15. The automatic workpiece supply system of claim 14 wherein the pallet retriever is further configured to take a pallet from the load/unload station and load the pallet into the pallet supply.

16. A method of exchanging a workpiece in a CNC machining center, the method comprising:
(A) receiving by a workpiece retrieval unit a new workpiece request from the CNC machining center;
(B) retrieving by the workpiece retrieval unit from a workpiece supply, a new pallet supporting at least one new workpiece;
(C) receiving the workpiece retrieval unit bearing the new pallet supporting the at least one new workpiece into the CNC machining center;
(D) exchanging, by the workpiece retrieval unit a finished pallet supporting at least one finished workpiece for the new pallet; and
(E) removing, by the workpiece retrieval unit, the finished pallet supporting the finished workpiece from the CNC machining center.

17. The method of claim 16 wherein the exchanging comprises:
(A) engaging the finished pallet by the workpiece retrieval unit;
(B) removing, by the workpiece retrieval unit, the finished pallet from engagement with the CNC machining center;
(C) positioning, by the workpiece retrieval unit, the new pallet in engagement with the CNC machining center; and
(D) removing the workpiece retrieval unit bearing the finished pallet from the CNC machining center.

18. The method of claim 17 wherein the CNC machining center comprises a clamping base comprising a locking mechanism for lockingly engaging a pallet to the clamping base, wherein the removing, by the workpiece retrieval unit, the finished pallet from engagement with the CNC machining center comprises unlocking the locking mechanism by the workpiece retrieval unit.

19. The method of claim 18 wherein the locking mechanism comprises at least one air locking mechanism, the method comprising supplying, by the workpiece retrieval unit, pressurized air to the at least one air locking mechanism.

20. The method of claim 18 comprising actuating the locking mechanism by the workpiece retrieval unit to lock the new pallet to the clamping base.

21. The method of claim 16 comprising providing a signal from the workpiece retrieval unit to the CNC machining center to actuate a door of the CNC machining center that provides entry to the CNC machining center for the workplace retrieval unit.

22. An automatic workpiece supply system for supplying one or more workpieces to a CNC machining system, the automatic workpiece supply system comprising:
(A) pallet supply means for storing a plurality of pallets configured to support at least one workpiece;
(B) pallet retriever means for retrieving a pallet supporting at least one workpiece to be machined from the pallet supply means and supplying the retrieved pallet to the CNC machining system.

23. The automatic workpiece supply system of claim 22 wherein the pallet supply comprises shelf means for supporting a plurality of pallets.

24. The automatic workpiece supply system of claim 23 wherein the pallet retriever means comprises gantry means for supporting a pallet retrieval unit means for retrieving a pallet from the shelf means.

25. The automatic workpiece supply system of claim 22 comprising control means for actuating a door of the CNC machining system.

26. The automatic workpiece supply system of claim 22 wherein the pallet retriever means comprising pallet clamping base engagement means for engaging a pallet clamping base within the CNC machining system that supports a pallet, and pallet engagement means for engaging the pallet on the clamping base.

27. The automatic workpiece supply system of claim 26 comprising locking actuation means for actuating a locking system that locks a pallet to the pallet clamping base.

28. The automatic workpiece supply system of claim 27 wherein the locking actuation means comprises pneumatic means for providing pressurized air to a pneumatic lock of the pallet clamping base.
